(19) United States
(12) Patent Application Publication
(10) Pub. No.: US 2021/0367746 A1
(43) Pub. Date: Nov. 25, 2021

(54) SIMPLEX AND DUPLEX DISTRIBUTED ANTENNA SYSTEM

(71) Applicant: Fiplex Communications, Inc., Doral, FL (US)

(72) Inventor: Ricardo Matias de Goycoechea, Cordoba (AR)

(73) Assignee: Fiplex Communications, Inc., Doral, FL (US)

(21) Appl. No.: 17/324,767

(22) Filed: May 19, 2021

Related U.S. Application Data
(60) Provisional application No. 63/027,116, filed on May 19, 2020.

(51) Int. Cl. H04L 5/16; H04W 72/08; H04B 17/382; H04B 17/318

(52) U.S. Cl. CPC H04L 5/16; H04W 72/082; H04B 17/318; H04B 17/382; H04W 72/085

(57) ABSTRACT

The disclosed system includes the incorporation into a Distributed Antenna System (DAS) for telecommunications applications, the capability to communicate signals in a simplex configuration within the DAS coverage area.

### CROSS REFERENCE TO RELATED APPLICATIONS

This application claims the benefit of U.S. Provisional Application No. 63/027,116 filed May 19, 2020, the disclosure of which is hereby incorporated herein by reference in its entirety.

### FIELD OF THE DISCLOSURE

This disclosure relates generally to antenna systems for distributing signals in a communications network.

### BACKGROUND

Radiocommunications systems are widely used to provide communications services to different types of users, such as private companies, armed forces, governmental agencies, as well as public safety agencies. Those communication systems enable the users to exchange information in real time, coordinate tasks of different operating groups, allow the users to attend to and deal with emergency situations, as well as provide a communication link between or among users. Within the communications field, telecommunications in particular facilitate the provision of services that allow the aforementioned objectives to be met, since, through electromagnetic waves, information is sent from one point to another, either as an audio message or digital data.

Electromagnetic waves, which form the basis for the wireless transmission of information in any telecommunications system, propagate through the air at speeds close to the speed of light, but as they propagate, they are attenuated, that is, they lose strength. The quality of the information received by a wireless receiver (or Terminal Equipment, or Radio) depends largely on the strength of the electromagnetic wave, or also referred herein as a “radio signal.” The more the radio signal propagates or travels through the air, the more the signal is attenuated which can result in the loss of high quality communication of information. Air is not the only medium of propagation that produces loss of information quality due to the attenuation of (or loss of the strength of) the radio signals. Any other physical barrier interposed between a transmitter and a receiver will have to be penetrated by the radio signal to reach its intended recipient, and when the radio signal propagates through that physical barrier, the physical barrier will impact the amplitude of the radio signal, resulting in attenuation. The attenuation caused by physical structures is always a problem that must be addressed by the designer of the telecommunication system, and there is no practical way to avoid it. Exemplary physical barriers include walls, ceilings, or any other physical structure through which the radio signal must propagate while travelling along its path from a base station (in cellular communication systems) to the Radio. The communication of radio signals from a base station to a radio can be half duplex or full duplex, and vice versa. Communication from one radio to another, without relying on a base station, can also be half duplex or full duplex. From the foregoing, it is evident that one of the most difficult problems that the radiocommunication users encounter in the use of their telecommunications systems relates to how these systems can be made to work properly in closed spaces, where the radio signals lose strength as they propagate through physical barriers.

There are several existing solutions that attempt to solve signal coverage problems in the telecommunications systems. Most of these solutions are based on installing systems that receive signals from base stations (or other signal sources), amplify the signals, and retransmit the signals throughout the interior of a building or other indoor area towards radio transceivers. These existing solutions may be based on the use of a signal booster that bi-directionally amplifies the signals transmitted from the base station to the radio transceivers and from the radio transceivers to the base station. In the downlink direction, signals from the base station are received by a donor antenna that points at the base station, and after being amplified by the signal booster, the signals are distributed throughout the interior of the closed environment (indoor environment) through a passive radio frequency distribution network and indoor antennas to provide a signal coverage area for radio transceivers within the closed environment. In the opposite direction (uplink), the signals transmitted by the radio transceivers are captured by the indoor antennas, reach the signal booster through the passive radio frequency distribution network, and are then amplified by the signal booster and radiated to the Base Station through use of the donor antenna.

When the indoor area subject to coverage is exceptionally large, then instead of using a signal booster, a system using multiple amplifier elements known in the industry as Distributed Antenna System, or DAS, may be used. These DAS systems have an operation that is similar to that of a signal booster but which can cover larger areas through use of more antennas.

All of these current solutions have many drawbacks in their application. Typically, the limitation of these solutions that is the most difficult to overcome is the capability to provide direct radio to radio communications within an enclosed area, especially when the two radios attempting direct communication with each other transmit and receive signals in the same frequency, what may be referred to as simplex communications. Specifically, the term “simplex” in the two-way radio or LMR world may refer to a method for establishing communication in which a radio transmits radio signals and receives radio signals from a radiocommunications link, where transmitted and received radio signals both have the same center frequency. Simplex communication can encompass time domain duplexing (“TDD”) communications, or direct mode operation (“DMO”) communications as referred to in Europe.

To establish simplex communications, a Base Station is not required to receive the signal transmitted by the transmitting Radio and to retransmit it to the receiver Radio, which a Base Station would typically do on different reception and retransmission frequencies. Simplex communications may be established when a Radio transmits a signal on a frequency, and a second or a group of other Radios receive that signal in that frequency. A Signal Booster for radio communications systems amplifies two links, for example, in the downlink direction from the Base Station to the Radios, and in the uplink direction from the Radios to the Base Station. Both the downlink and the uplink signals can be communicated using a single frequency channel or a using a subset of frequency channels, but typically the downlink and uplink signals are not communicated in a telecommunication system in the same frequency channel simultaneously (at the same time). A Signal Booster may include at least one port for wired or wireless connection with the Base Station and may include at least another port for wired or wireless connection to the Radios that may lie inside or move within an enclosed or indoor area, in which case signals transmitted by the Radios are amplified and retransmitted by the Signal Booster to Base Station, which has a fixed location outside the enclosed or indoor area.

Distributed Antenna Systems, which may include at least one Master Unit having at least one port for wired or wireless connection to the Base Station, and by at least one Remote Unit having at least one port that for wired or wireless connection to the Radios that lie inside or move within the enclosed or indoor area. The Distributed Antenna System amplifies two links, the downlink from the Base Station to the Radios, and the uplink from the Radios to the Base Station. Both the downlink and the uplink signals can be communicated using a single frequency channel or a using a subset of frequency channels, but typically the downlink and uplink signals are not communicated in a telecommunication system in the same frequency channel simultaneously (at the same time), which means that signals transmitted by the Radios will be amplified and retransmitted to the external Base Station by the Distributed Antenna System.

Therefore, in view of these disadvantages, there is a need in the art for an improved antenna system with the capability to provide direct radio to radio communications within an enclosed area.

### SUMMARY

The following presents a simplified summary of the invention in order to provide a basic understanding of some aspects of the invention. This summary is not an extensive overview of the invention. Rather than specifically identifying key or critical elements of the invention or to delineate the scope of the invention, its purpose, inter alia, is to present some concepts of the invention in a simplified form as a prelude to the more detailed description that is presented later.

The present disclosure relates to the incorporation into a Distributed Antenna System (DAS) for telecommunications applications, the capability to communicate signals in a simplex configuration within the DAS coverage area.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following description of the invention when considered in conjunction with the drawings.

### BRIEF DESCRIPTION OF THE FIGURES

The drawings, in which like numerals represent similar parts, illustrate generally, by way of example, but not by way of limitation, various embodiments discussed in the present document.

FIG. 1 shows a DAS that includes one Master Unit (MU) that is connected to two Remote Units (RU) in accordance with one embodiment.

FIG. 2 shows a DAS that includes one Master Unit (MU) that is connected to two Remote Units (RU) in accordance with one embodiment.

FIG. 3 shows a DAS that includes one Master Unit (MU) that is connected to three Remote Units (RU) in accordance with one embodiment.

FIG. 4 shows a DAS that includes one Master Unit (MU) that is connected to three Remote Units (RU) in accordance with one embodiment.

FIG. 5 shows a DAS that includes one Master Unit (MU) that is connected to three Remote Units (RU) in accordance with one embodiment.

FIG. 6 shows a DAS that includes one Master Unit (MU) that is connected to two Remote Units (RU) in accordance with one embodiment.

FIG. 7 illustrates shows a DAS that includes one Master Unit (MU) that is connected to two Remote Units (RU) in accordance with one embodiment.

### DETAILED DESCRIPTION OF THE DISCLOSURE

The foregoing summary, as well as the following detailed description of certain embodiments of the subject matter set forth herein, will be better understood when read in conjunction with the appended drawings. In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that variations may be made without departing from the scope of the subject matter disclosed herein. It should also be understood that the drawings are not necessarily to scale and in certain instances details may have been omitted, which are not necessary for an understanding of the disclosure, such as details of fabrication and assembly. Furthermore, references to “one embodiment” are not intended to be interpreted as excluding the existence of additional embodiments that also incorporate the recited features. The following detailed description is, therefore, not to be taken in a limiting sense, and the scope of the subject matter disclosed herein is defined by the appended claims and their equivalents.

The present description describes a system that solves the problems with the prior art. The exemplary implementations described herein include the incorporation into a Distributed Antenna System (DAS) for telecommunications applications, the capability to communicate signals in a simplex configuration within the DAS coverage area.

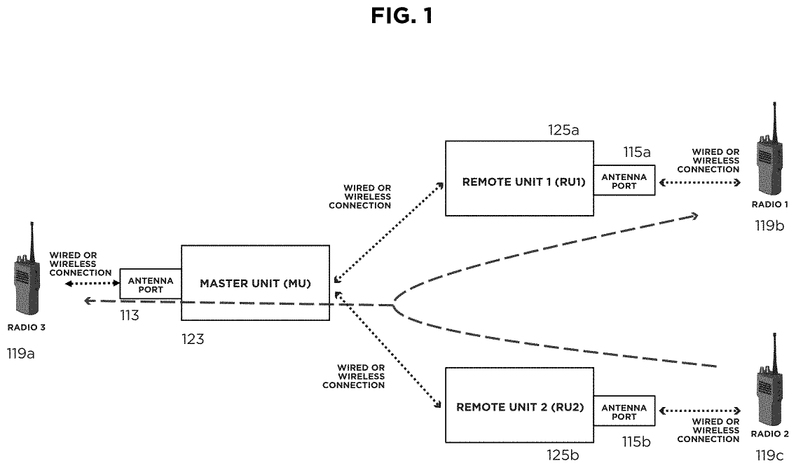

FIG. 1 shows a DAS that includes at least one Master Unit (MU) 123 that is connected (through a wired connection or wirelessly) to at least two Remote Units (RUs) 125a-b in a star configuration, where RU2 125b receives a radiofrequency signal from Radio 2 (119c), with Radio 2 being connected (through a wired connection or wirelessly) to RU2 (125b), with RU2 (125b) sending the received radiofrequency signal through the wired or wireless connection to the MU 123 and/or RU1 (125a). RU1 (125a) and/or MU (123) may transmit the received radiofrequency signal to at least one other Radio located in their respective coverage area, for example to Radio 3 (119a) in the MU coverage area or to Radio 1 (119b) in the RU1 coverage area. In one implementation MU (123) and RU1 (125a) may transmit the signal from RU2 (125b) to Radios in their respective coverage areas, or either MU (123) or RU1 (125a) alone may transmit the signal from RU2 (125b), depending on how the system is configured by the system operator. The system operator may be defined as a person that is able to program or configure the microcontroller(s) in the MU or RUs through an interface such as USB, Ethernet connection, etc. The system operator may also be defined as the core of one or more base transceiver stations that instruct the microcontroller how to configure the demodulators and modulators, for example.

Radios 1 (119b) and 3 (119a) are respectively connected (through a wired connection or wirelessly) to at least one port (115a) of RU1 and at least one port (113) of MU, where the radiofrequency signal received from Radio 2 (119c) at RU2 (125b) has the same center frequency as center frequency of the signals that may be transmitted by RU1 (125a) to Radio 1 (119b) (in RU1 coverage area) and/or MU (123) to Radio 3 (119a) (in MU coverage area). In one implementation of the present disclosure, the decision whether to relay or retransmit the radiofrequency signal received from RU2 to Radios in the coverage areas corresponding to either RU1 or MU (or both) is made by MU, RU1, RU2, or all or some of the MU and RU units, based on certain criteria. Conflict is avoided because in the event of a potential collision or coincidence, the MU and RU control units negotiate a communication route in accordance with predefined rules. For example, system operator can configure or set all such criteria pertaining to the intended Radio receivers.

In addition, the decision may be made by microcontrollers units (not illustrated) in MU and/or RUs in accordance with overall system statistics or overall system status. In one exemplary implementation, if the MU 123 and/or RU1 (125a) sense that there are Radios lying or moving in their respective coverage areas, MU 123 and/or RU1 (125a) may decide whether to retransmit the signal from RU2 (125b) to those Radios (119a and/or 119b). MU 123 and/or RU1 (125a) may detect the presence of the Radios in their respective coverage areas if they receive any signal from their associated Radios (e.g., associated by virtue of being in the respective coverage area), and will therefore know that there are radios in their respective coverage areas. Other methods may be relied upon by the MU and RU1 to allow them to decide whether to transmit the RU2 signals or not to Radios in their respective coverage areas, such as signal strength or other signal characteristics, as understood by persons skilled in the art. All or some of the Radios of the present disclosure may be implemented as radiofrequency transmitters or radiofrequency transceiver devices.

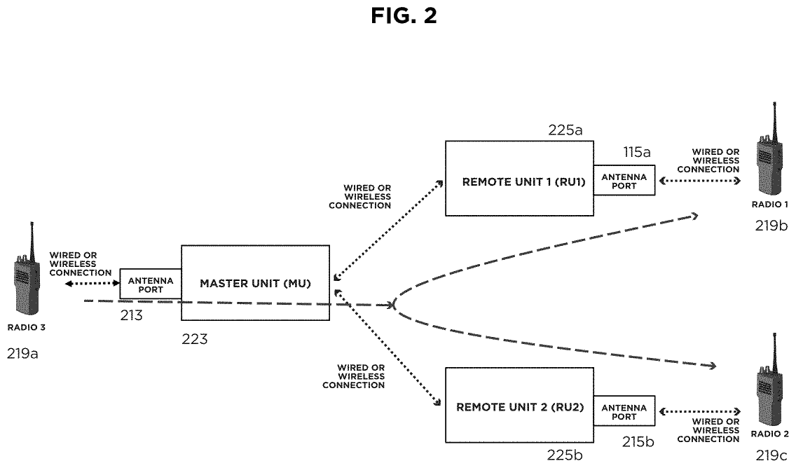

FIG. 2 shows another embodiment of the DAS of FIG. 1. In the implementation illustrated in FIG. 2, the MU (223) receives a radiofrequency signal from Radio 3 (219a), which is connected (through a wired connection or wirelessly) to MU (223), with MU (223) sending the radiofrequency signal received from Radio 3 (219a) through the wired or wireless connection, to RU1 (225a) and/or RU2 (225b). RU1 (225a) and/or RU2 (225b) may transmit the received radiofrequency signal to at least one other Radio located in their respective coverage area, for example to Radio 2 (219c) in the RU2 coverage area, or to Radio 1 (219b) in the RU1 coverage area. Radios 1 and 2 are respectively connected (through a wired connection or wirelessly) to at least one port 215a of RU1 and at least one port 215b of RU2, where the radiofrequency signal received from Radio 3 (219a) at MU 223 has the same center frequency as the center frequency of signals transmitted by RU1 to Radio 1 (in RU1 coverage area) and/or RU2 to Radio 2 (in RU2 coverage area). In one implementation of the present disclosure, the decision whether to relay or retransmit the radiofrequency signal received from MU to Radios in the coverage areas corresponding to either RU1 or RU2 (or both) is made by MU, RU1, RU2, or all or some of the MU and RU units, based on certain criteria as explained above.

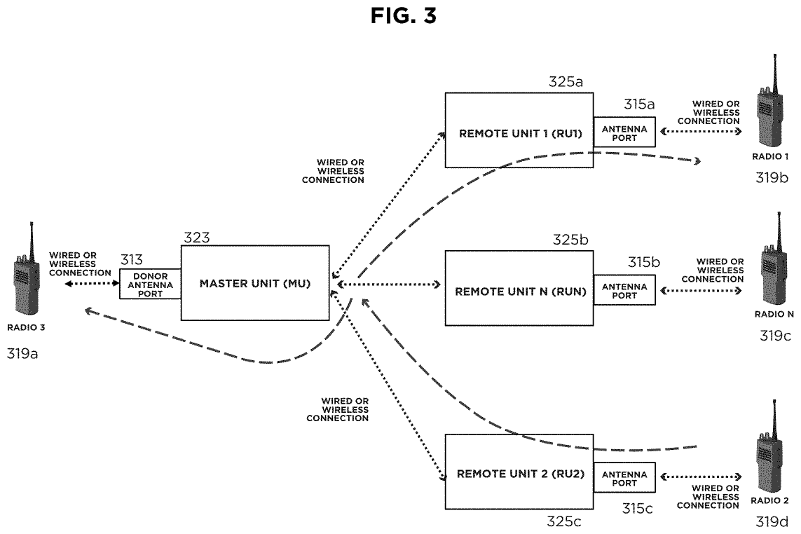

FIG. 3. shows another embodiment of the DAS of FIG. 1. In the implementation illustrated in FIG. 3, at least a third RU (RUN) 325b is part of the DAS and is also connected to the MU 323 through a wired or wireless connection, and the radiofrequency signal received by RU2 (325c) from Radio 2 (319d) may be relayed or retransmitted by RU2 (325c) to MU 323 and/or RU1 (325a), but not to RUN (325b), where the radiofrequency signal received from Radio 2 (319d) at RU2 (325c) has the same center frequency as the center frequency of signals transmitted by RU1 (325a) to Radio 1 (319b, in RU1 coverage area) and/or MU 323 to Radio 3 (319a) (in MU coverage area). The decision to specifically relay or retransmit the signal received from Radio 2 (319d) to Radios in the coverage areas corresponding to either MU 323 and/or RU1 325a (or both) is made by MU, RU1, RU2, RUN, or all or some of the MU and RU units, based on certain criteria as described above.

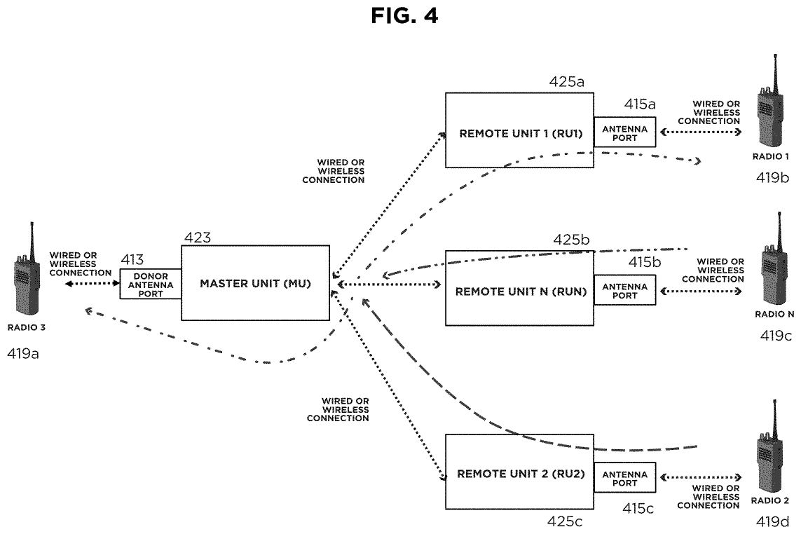

FIG. 4 shows a DAS with at least one MU 423 connected to at least three RUs through a wired or wireless connection, where RU2 (425c) receives a radiofrequency signal from Radio 2 (419d), which is wired to or wirelessly connected with RU2 (425c), where RUN (425b) receives a radiofrequency signal from Radio N (419c), which is wired to or wirelessly connected with RUN (425b), where the center frequency of the radiofrequency signal received at RU2 (425c) from Radio 2 (419d) is the same as the center frequency of radiofrequency signal received by RUN (425b) from Radio N (419c), and also the same as the center frequency of the signals transmitted by RU1 (425a) to Radio 1 (419b, in RU1 coverage area) and/or RU2 (425c) to Radio 2 (419d, in RU2 coverage area).

In the implementation illustrated in FIG. 4, based on a decision made by the MU 423 and/or any RU unit and/or all or some of the MU and RU units, based on certain criteria as discussed above, only one of the radiofrequency signals received by RU2 (425c) or RUN (425b) will be relayed or retransmitted through the wired or wireless connection to Radios in the coverage areas corresponding to either MU (423) and/or RU1 (425a) (or both), with RU1 (425a) and/or MU 423 retransmitting or relaying the radiofrequency signal received by either RU2 (425c) or RUN (425b) (but not both) to at least one Radio located in the respective coverage area for MU and RU1, for example to Radio 3 (419a) in the MU coverage area or to Radio 1 (419b) in the RU1 coverage area.

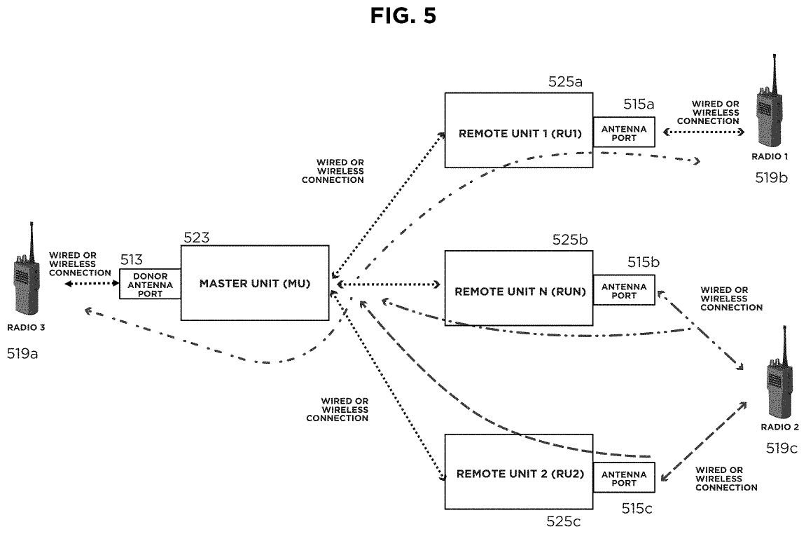

FIG. 5 shows a DAS with at least one MU 523 connected to at least three RUs through a wired or wireless connection, where RU2 (525c) receives a radiofrequency signal from Radio 2 (519c), which is wired to or wirelessly connected with RU2 (525c), where RUN (525b) receives the same radiofrequency signal from Radio 2 (519c), which is wired to or wirelessly connected with RUN (525b), where the center frequency of the radiofrequency signal received at RU2 (525c) from Radio 2 (519c) has the same center frequency as the center frequency of the radiofrequency signal received by RUN (525b) from Radio 2 519c (as RU2 and RUN receive the same signal), and where the radiofrequency signal received from Radio 2 (519c) at RU2 (525c) or RUN (525b) has the same center frequency as the center frequency of signals transmitted by RU1 (525a) to Radio 1 (519b, in RU1 coverage area) and/or MU 523 to Radio 3 (519a, in MU coverage area).

In the implementation illustrated in FIG. 5, based on a decision, made by of the MU and/or any RU unit and/or all or some of the MU and RU units, based on certain criteria as discussed above, only one of the radiofrequency signals received by RUN (525b) or RU2 (525c) will be relayed or retransmitted through the wired or wireless connection to the Radios in the coverage areas corresponding to either RU1 (525a) or MU 523 (or both), with RU1 (525a) and/or MU 523 retransmitting or relaying the radiofrequency signal received by either RU2 (525c) or RUN 525b (but not both) to at least one Radio located in their coverage area for MU 523 and RU1 (525a), for example Radios that are wired to or wirelessly connected with at least one port of MU and RU 1.

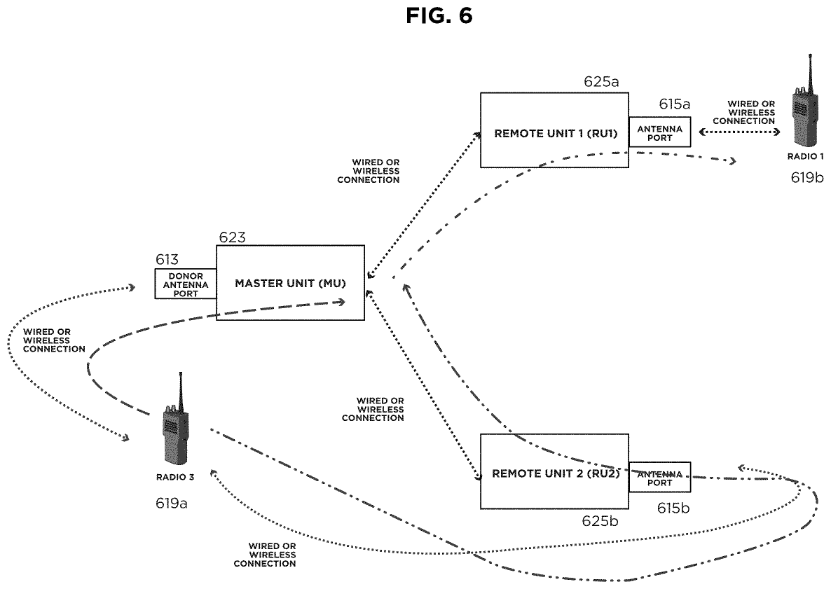

FIG. 6 shows a DAS with at least one MU 623 connected to at least two RUs through a wired or wireless connection, where RU2 (625b) receives a radiofrequency signal from Radio 3 (619a), which is wired to or wirelessly connected with RU2 (625b), where MU 623 receives the same radiofrequency signal from Radio 3 (619a), which is wired to or wirelessly connected with MU 623, where the center frequency of the radiofrequency signal received at RU2 (625b) from Radio 3 (619a) is the same as the center frequency of the radiofrequency signal received by MU 623 from Radio 3 (619a), and also the same as the center frequency of the signals transmitted by RU1 (625a) to Radio 1 (619b, in RU1 coverage area).

In the implementation illustrated in FIG. 6, based on a decision made by the MU and/or any RU unit and/or all or some of the MU and RU units, based on certain criteria as discussed above, only one of the radiofrequency signals received by RU2 (625b) or MU 623 will be relayed or retransmitted through the wired or wireless connection to at least Radio 1 (619b) in the coverage area corresponding to RU1 (625a), with RU1 (625a) retransmitting or relaying the radiofrequency signal received by either RU2 (625b) or MU 623 (but not both, either one or the other) to at least one Radio located in RU1's coverage area, for example Radio 1 (619b) which is wired to or wirelessly connected with at least one port of RU1 (625a). In another implementation, the decision of which of the radiofrequency signals (i.e., received by either MU 623 or RU2 (625b)) will be relayed or retransmitted to RU1 (625a) is made jointly by RU2 (625b) and MU 623.

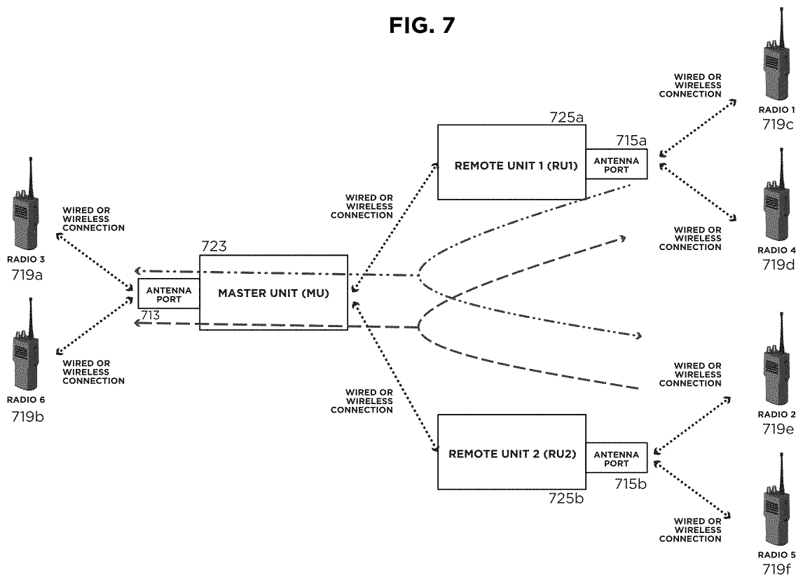

FIG. 7 shows a DAS with at least one MU 723 connected to at least two RUs through a wired or wireless connection. In the embodiment illustrated in FIG. 7, RU1 (725a) receives a radiofrequency signal from Radio 1 (719c), which is wired to or wirelessly connected with RU1 (725a), and RU2 (725b) receives a radiofrequency signal from Radio 2 (719e), which is wired to or wirelessly connected with RU2 (725b).

In one implementation, RU1 (725a) sends the radiofrequency signal received from Radio 1 (719c) through the wired or wireless connection to the MU 723 and/or RU2 (725b), where RU2 (725b) and/or MU 723 may relay or retransmit the radiofrequency signal received from RU1 (725a) to at least one Radio located in their respective coverage area, for example to Radios 3 (719a) and/or 6 (719b) in the MU coverage area or to Radios 2 (719e) and/or 5 (719f) in the RU2 coverage area. Radios 3 and 2 are respectively connected (through a wired connection or wirelessly) to at least one port of MU and RU2, where the radiofrequency signal received from Radio 1 (719c) at RU1 (725a) has the same center frequency as the center frequency of signals transmitted by RU2 and/or MU to the Radios 2 and/or 5 (RU2 coverage area) and 3 and/or 6 (MU coverage area). In one implementation of the present disclosure, the decision whether to relay or retransmit the radiofrequency signal received from RU1 to either RU2 or MU (or both) is made by the MU and/or any RU unit and/or all or some of the MU and RU units, based on certain criteria as discussed above.

In one implementation, RU2 (725b) sends the radiofrequency signal received from Radio 2 (719e) through the wired or wireless connection to the MU 723 and/or RU1 (725a), where RU1 (725a) and/or MU 723 may relay or retransmit the radiofrequency signal received from RU2 (725b) to at least one Radio located in their respective coverage area, for example to Radios 3 (719a) and/or 6 (719b) in the MU coverage area or to Radios 1 (719c) and/or 4 (719d) in the RU1 coverage area. Radios 3 (719a) and 1 (719c) are respectively connected (through a wired connection or wirelessly) to at least one port of MU and RU1, where the radiofrequency signal received from Radio 2 (719e) at RU2 (725b) has the same center frequency as center frequency of the signals transmitted by RU1 (725a) and/or MU 723 to the Radios 1 (719c) and/or 4 (719d, RU1 coverage area) and 3 (719a) and/or 6 (719b, MU coverage area).

The descriptions set forth above are meant to be illustrative and not limiting. Various modifications to the disclosed embodiments, in addition to those described herein, will be apparent to those skilled in the art from the foregoing description. Such modifications are also intended to fall within the scope of the concepts described herein. For example, while the present disclosure describes DAS star topologies, meaning that the Master Unit has a direct connection with each Remote, the concepts described herein may include implementations on DAS systems with daisy chain or dual daisy chain configurations. In addition, Radios may be wired to or wirelessly connected with the MU and RUs, and the MU and/or RUs may include have one or many antenna ports, and may or may not include input filters connected to the single or multiple antenna ports. Further, the Radio signals can be modulated using an analog or digital modulation scheme and can be transmitted in any band.

The description of some implementations should not be construed as an intent to exclude other implementations described. For example, artisans will understand how to implement the disclosed embodiments in many other ways, using equivalents and alternatives that do not depart from the scope of the disclosure. Moreover, unless indicated to the contrary in the preceding description, no particular component described in the implementations is essential to the invention. It is thus intended that the embodiments disclosed in the specification be considered illustrative, with a true scope and spirit of invention being indicated by the following claims.

Further, the limitations of the following claims are not written in means-plus-function format and are not intended to be interpreted based on 35 U.S.C. 112(f), unless and until such claim limitations expressly use the phrase “means for” followed by a statement of function void of further structure.

1. A distributed antenna system comprising:
a master unit in communication with first, second, and third remote units in a star configuration;
a first terminal equipment within the coverage area of the first remote unit;
a second terminal equipment within the coverage area of the second remote unit;
a third terminal equipment within the coverage area of the third remote unit;
a fourth terminal equipment within the coverage area of the master unit;
wherein the second remote unit receives a radiofrequency signal from the second terminal equipment;
wherein the third remote unit receives a radiofrequency signal from the third terminal equipment, where the center frequency of the radiofrequency signal received at the second remote unit from the second terminal equipment is the same as the center frequency of radiofrequency signal received by third remote unit from the third terminal equipment, and where the center frequency of the radiofrequency signal received at the second remote unit from the second terminal equipment is the same as the center frequency of the signals transmitted by the first remote unit to the first terminal equipment and the same as the center frequency of the signals transmitted by the second remote unit to the second terminal equipment.

2. The antenna system of claim 1, wherein the first remote unit and the master unit relay radio frequency signals received by the second remote unit or the third remote unit, but not both, to at least one terminal unit located in the respective coverage area for the master unit and first remote unit, including fourth terminal equipment in the master unit coverage area or first terminal equipment in the first remote unit coverage area.

3. The antenna system of claim 2, wherein a decision as to whether the first remote unit and the master unit relay radio frequency signals received by the second remote unit or the third remote unit, but not both, is made by the master unit, by any of the remote units, by the master unit and all of the remote units, or by a subset of the master unit and the remote units, based on predefined rules.

4. The antenna system of claim 3, wherein the predefined rules are set by a system operator.

5. The antenna system of claim 3, wherein the predefined rules are set by a microcontroller located in the master unit or any of the remote units.

6. The antenna system of claim 3, wherein the predefined rules relate to the detection of terminal equipment in coverage areas.

7. The antenna system of claim 3, wherein the predefined rules relate to the detection of signal strength of terminal equipment.

8. The antenna system of claim 3, wherein the predefined rules are based on noise statistics.

9. The antenna system of claim 1, wherein the first remote unit and the master unit relay radio frequency signals received by the second remote unit or the third remote unit, or both, to at least one terminal unit located in the respective coverage area for the master unit and first remote unit, including fourth terminal equipment in the master unit coverage area or first terminal equipment in the first remote unit coverage area.

10. The antenna system of claim 9, wherein a decision as to whether the first remote unit and the master unit relay radio frequency signals received by the second remote unit or the third remote unit, or both, is made by the master unit, by any of the remote units, by the master unit and all of the remote units, or by a subset of the master unit and the remote units, based on predefined rules.

11. The antenna system of claim 10, wherein the predefined rules are set by a system operator.

12. The antenna system of claim 10, wherein the predefined rules are set by a microcontroller located in the master unit or any of the remote units.

13. The antenna system of claim 10, wherein the predefined rules relate to the detection of terminal equipment in coverage areas.

14. The antenna system of claim 10, wherein the predefined rules relate to the detection of signal strength of terminal equipment.

15. The antenna system of claim 10, wherein the predefined rules are based on noise statistics.
